(19) United States
(12) Patent Application Publication
(10) Pub. No.: US 2026/0043342 A1
(43) Pub. Date: Feb. 12, 2026

(54) ENGINE COMPARTMENT STRUCTURE FOR VEHICLE

(71) Applicant: TOYOTA JIDOSHA KABUSHIKI KAISHA, Toyota-shi (JP)

(72) Inventor: Toshinori OKI, Toyota-shi (JP)

(73) Assignee: TOYOTA JIDOSHA KABUSHIKI KAISHA, Toyota-shi (JP)

(21) Appl. No.: 19/276,089

(22) Filed: Jul. 22, 2025

(30) Foreign Application Priority Data
Aug. 6, 2024 (JP) 2024-129807

(51) Int. Cl. F01N 3/20; B60K 6/405; F02M 26/14; F02M 26/17

(52) U.S. Cl. CPC F01N 3/2013; B60K 6/405; F02M 26/14; F02M 26/17

(57) ABSTRACT

An engine compartment structure for a vehicle includes an engine that is located in the engine compartment, an EHC that generates heat when energized including a catalyst carrier carrying a catalyst, and the electrically heated catalyst and the exhaust pipe define a flow passage for the exhaust gas in the engine compartment, and a second EHC cable that connects the EHC and a power supply device that supplies electric power to the EHC. At least a part of the second EHC cable is located at an upper side of an upper end surface of a cylinder head of the engine.

### CROSS-REFERENCE TO RELATED APPLICATIONS

This application is based upon and claims the benefit of priority from Japanese Patent Application No. 2024-129807, filed on Aug. 6, 2024, the entire contents of which are incorporated herein by reference.

### BACKGROUND

### 1. Field

The following description relates to an engine compartment structure for a vehicle.

### 2. Description of Related Art

Japanese Laid-Open Patent Publication No. 9-32533 discloses an exhaust pipe for an engine that includes an electrically heated catalyst. The electrically heated catalyst includes a catalyst carrier and two terminals. A catalyst is supported by the catalyst carrier. Two terminals are attached to the catalyst carrier. The two terminals are connected to a battery by cables. The catalyst carrier generates heat when energized through the cables and the two terminals. The part of the cable proximate to the terminal is formed from a material having higher heat capacity than other parts of the cable so that the temperature near the terminal does not become high.

In a technique such as that disclosed in Japanese Laid-Open Patent Publication No. 9-32533, when energizing the catalyst carrier, the entire cable between the portion connected to the battery and the portion connected to the terminal has a tendency to become hot. Moreover, depending on the layout in the engine compartment, heat may not be sufficiently dissipated from the entire cable. As a result, the entire cable may become overheated. Japanese Laid-Open Patent Publication No. 9-32533 proposes a solution for limiting temperature increases at the part of the cable proximate to the terminal but not at other parts of the cable.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure provides an engine compartment structure for a vehicle. In one general aspect, the engine compartment structure for a vehicle, the engine compartment structure includes an engine located in the engine compartment of the vehicle. An exhaust pipe extends from the engine in which the exhaust gas from the engine flows through the exhaust pipe. An electrically heated catalyst that generates heat when energized includes a catalyst carrier carrying a catalyst, and the electrically heated catalyst and the exhaust pipe define a flow passage for the exhaust gas in the engine compartment. A cable connects the electrically heated catalyst and a power supply device that supplies electric power to the electrically heated catalyst in which at least a part of the cable is located at an upper side of an upper end surface of a head cover that covers a cylinder head of the engine.

Other features and aspects will be apparent from the following detailed description, the drawings, and the claims.

### BRIEF DESCRIPTION OF THE DRAWINGS

FIG. 1 is a left view of an engine compartment schematically illustrating the layout of members.

FIG. 2 is a rear view of the engine compartment schematically illustrating the layout of members.

FIG. 3 is a plan view of the engine compartment schematically illustrating the layout of members.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An engine compartment structure applied to a plug-in hybrid electric vehicle will now be described as an example of one embodiment of an engine compartment structure. In the present embodiment, the frame of reference for the terms up, down, left, right, front, and rear will be based on a state in which the driver of the vehicle is seated facing the front of the vehicle. The drawings schematically show the engine compartment structure for the vehicle in a simplified manner. Further, the shown elements have not necessarily been drawn to scale and may be exaggerated to aid understanding.

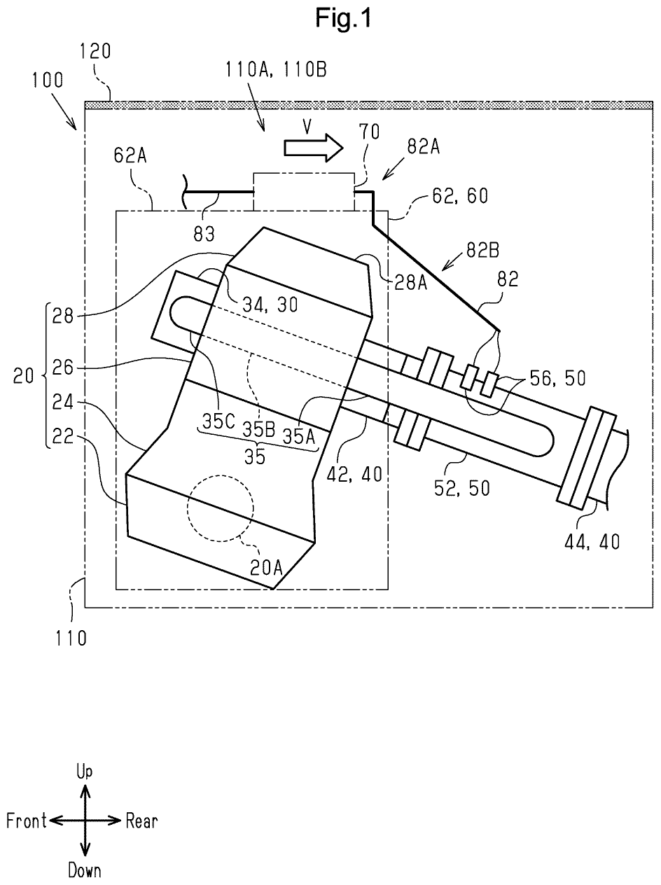

As shown in FIG. 1, a vehicle 100 includes an engine compartment 110. The engine compartment 110 is defined by a space in the front part of the vehicle 100. The engine compartment 110 is defined by a space formed by a dash panel and fender panels (not shown). The dash panel separates a passenger compartment of the vehicle 100 from the engine compartment 110. The fender panels form the left and right outer walls in the front part of the vehicle 100.

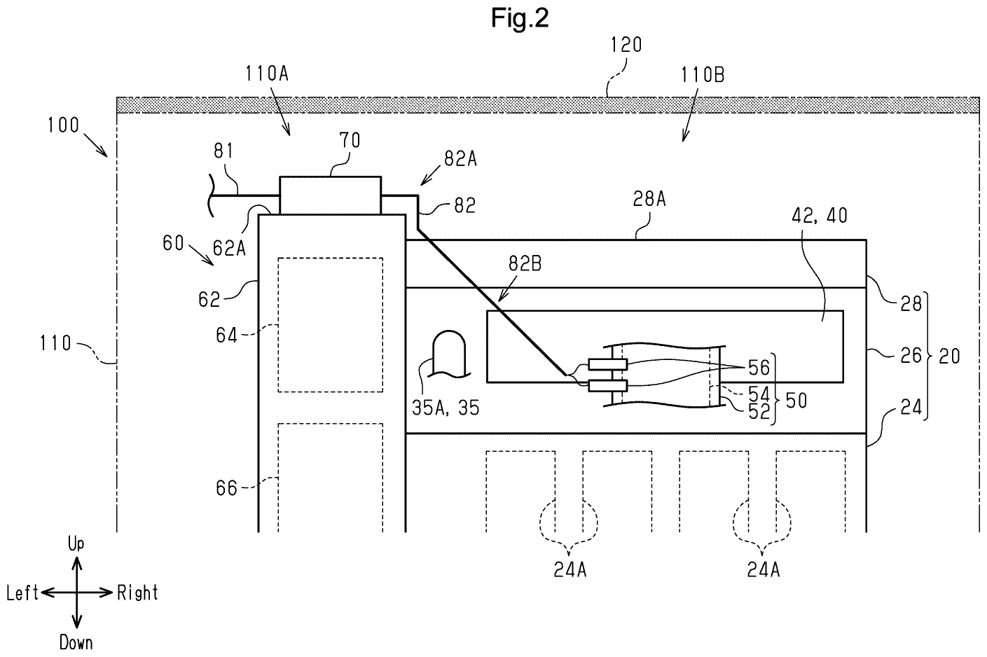

The vehicle 100 includes a hood 120. The hood 120 covers the engine compartment 110 from above. The hood 120 is, for example, a rectangular plate. The hood 120 is configured to open and close the upper opening of the engine compartment 110. In FIGS. 1 and 2, the hood 120 is shaded.

### Engine

As shown in FIG. 1, the vehicle 100 includes an engine 20. The engine 20 is located in the engine compartment 110. The engine 20 includes an oil pan 22, a cylinder block 24, a cylinder head 26, a head cover 28, and a crankshaft 20A. The oil pan 22, the cylinder block 24, the cylinder head 26, and the head cover 28 are arranged one above another in order from the lower side. The crankshaft 20A is arranged between the oil pan 22 and the cylinder block 24. The engine 20 is slightly inclined so that the rear section of the engine 20 is lower than the front section of the engine 20.

The oil pan 22 is box-shaped in its entirety. The oil pan 22 has an opening upper end. The oil pan 22 contains lubricating oil.

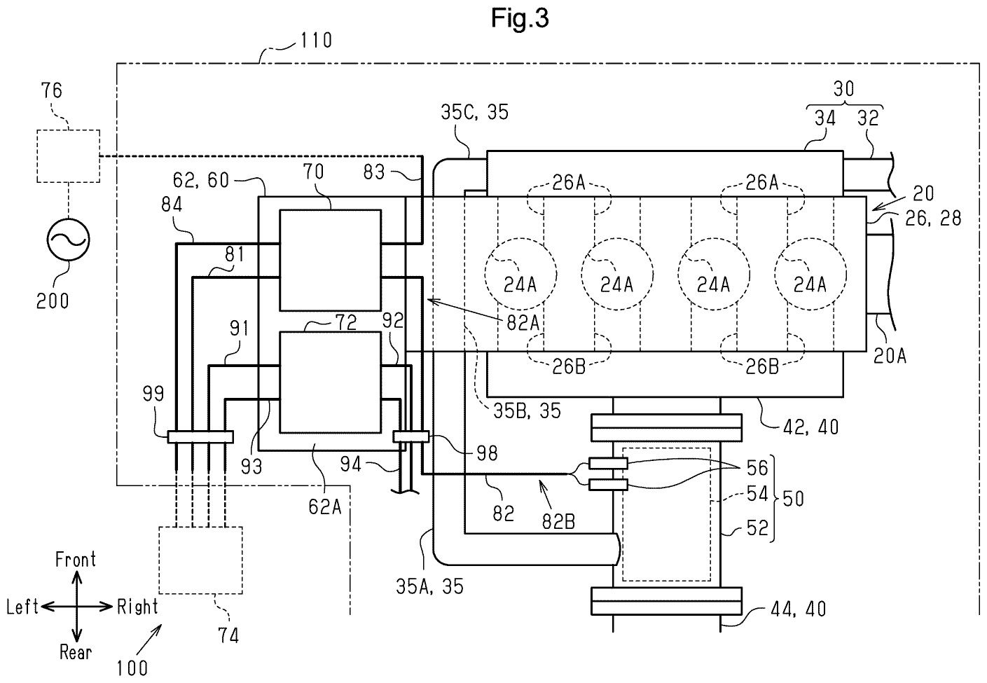

The cylinder block 24 has the form of a rectangular parallelepiped in its entirety. The cylinder block 24 widens toward the bottom in a side view. As shown in FIG. 2, the cylinder block 24 includes cylinders 24A. The cylinders 24A are spaces for combusting fuel. There are, for example, four cylinders 24A. The multiple cylinders 24A are arranged in the transverse direction. As shown in FIG. 3, the crankshaft 20A extends in the direction in which the cylinders 24A are arranged next to one another. The crankshaft 20A is rotated by the combustion of fuel in the cylinders 24A.

The cylinder head 26 has the form of a rectangular parallelepiped in its entirety. The cylinder head 26 includes intake ports 26A and exhaust ports 26B. Each intake port 26A guides intake air to a corresponding one of the cylinders 24A. Each exhaust port 26B discharges exhaust gas from a corresponding one of the cylinders 24A. In this manner, an intake port 26A is provided for each cylinder 24A. Further, an exhaust port 26B is provided for each cylinder 24A.

As shown in FIG. 1, the head cover 28 covers the upper side of the cylinder head 26. The head cover 28 is box-shape in its entirety. The head cover 28 has an open lower end. A spark plug (not shown) is attached to the head cover 28 for each cylinder 24A. The spark plug ignites the air-fuel mixture in the corresponding cylinder 24A. An injector (not shown) is attached to the head cover 28 for each cylinder 24A. The injector supplies fuel to the corresponding cylinder 24A. The injector may be attached to the cylinder head 26 instead of the head cover 28. The head cover 28 includes an upper end surface 28A that is the uppermost end of each of the head cover 28 and the engine 20. More precisely, since the engine 20 is inclined, the frontmost part of the upper end surface 28A of the head cover 28 is the uppermost end of the head cover 28 and the uppermost end of the engine 20. Thus, the uppermost end of the engine 20 is the uppermost end of the head cover 28 and not the upper end of a component attached to the engine 20.

### Intake Pipe

As shown in FIG. 1, the vehicle 100 includes an intake pipe 30. The intake pipe 30 is located at the front side of the engine 20. As shown in FIG. 3, the intake pipe 30 includes an intake manifold 34 and an upstream pipe 32. The intake manifold 34 is fixed to a front surface of the cylinder head 26. Intake air is drawn into the intake manifold 34 from the upstream pipe 32. The intake manifold 34 distributes the intake air drawn from the upstream pipe 32 to each intake port 26A. The intake air distributed to each intake port 26A is drawn into the corresponding cylinder 24A. Thus, the intake pipe 30 guides intake air to each cylinder 24A.

### Exhaust Pipe and Electrically Heated Catalyst

As shown in FIG. 1, the vehicle 100 includes an exhaust pipe 40 and an electrically heated catalyst (EHC) 50. The exhaust pipe 40 is located at the rear side of the engine 20. The exhaust pipe 40 in its entirety extends rearward and downward from the engine 20. The exhaust pipe 40 includes an exhaust manifold 42 and a downstream pipe 44.

As shown in FIG. 3, the exhaust manifold 42 is fixed to a rear surface of the cylinder head 26. The exhaust gas from each cylinder 24A and each exhaust port 26B is merged in the exhaust manifold 42. The downstream pipe 44 is connected to the exhaust manifold 42 by the EHC 50, which will be described below. The downstream pipe 44 is cylindrical in its entirety. The downstream pipe 44 extends rearward from the portion connected to the EHC 50. A bottom portion of the downstream pipe 44 extends out of the engine compartment 110.

As shown in FIG. 3, the EHC 50 is located in the engine compartment 110. In the engine compartment 110, the EHC 50 and the exhaust pipe 40 define a flow passage for exhaust gas. Thus, the exhaust gas from the engine 20 flows through the exhaust pipe 40 and the EHC 50. The EHC 50 is connected to a portion of the exhaust manifold 42 at the opposite side of the cylinder head 26. The EHC 50 is cylindrical in its entirety. The EHC 50 extends rearward from the portion connected to the exhaust manifold 42. The rear end of the EHC 50 is connected to the downstream pipe 44. The EHC 50 is located proximate to the transverse center of the engine 20.

The EHC 50 will now be described. As shown in FIG. 3, the EHC 50 includes a case 52, a catalyst carrier 54, and two electrodes 56. The case 52 is cylindrical. The case 52 forms the outer shell of the EHC 50. The catalyst carrier 54 is located inside the case 52. The catalyst carrier 54 is formed from an electrically resistive material that generates heat when energized. For example, silicon carbide may be used as such a material. The catalyst carrier 54 has a cylindrical profile. A honeycomb passage extends inside the catalyst carrier 54. The catalyst carrier 54, for example, carries a catalyst such as platinum, palladium, and rhodium. The two electrodes 56 are connected to the outer surface of the catalyst carrier 54 and project out of the case 52. The two electrodes 56 are supplied with electric power from a power supply device 70, which will be described below. The catalyst carrier 54 generates heat when energized through the electrodes 56. When the catalyst carrier 54 generates heat, the catalyst is heated. Subsequently, the catalyst becomes active.

### Exhaust Gas Recirculation Pipe

As shown in FIG. 1, the vehicle 100 includes an exhaust gas recirculation (EGR) pipe 35. The EGR pipe 35 includes an upstream portion 35A, an intermediate portion 35B, and a downstream portion 35C. The upstream portion 35A is a cylindrical pipe. The intermediate portion 35B is a passage defined by the cylinder head 26. As shown in FIG. 3, the intermediate portion 35B is located at the left end of the cylinder head 26. The intermediate portion 35B extends through the cylinder head 26 in the front-rear direction. The downstream portion 35C is a cylindrical pipe. As shown in FIG. 3, the upstream portion 35A includes a first end that is connected to a downstream portion of the EHC 50. The upstream portion 35A extends leftward from the first end and is then bent forward. The upstream portion 35A includes a second end that is connected to an opening in the rear surface of the cylinder head 26, which is a part of the intermediate portion 35B. The upstream portion 35A extends from the EHC 50 and connects to the intermediate portion 35B. The downstream portion 35C includes a first end that is connected to an opening in the front surface of the cylinder head 26, which is a part of the intermediate portion 35B. The downstream portion 35C extends forward from the first end and is then bent rightward. The downstream portion 35C includes a second end that is connected to the intake manifold 34. The downstream portion 35C is connected to the intake pipe 30, and the downstream portion 35C and the EHC 50 are located at opposite sides of the cylinder head 26. The EGR pipe 35 recirculates the exhaust gas flowing through the exhaust pipe 40 and the EHC 50 to the intake pipe 30. A valve is arranged in the EGR pipe 35 to control the amount of exhaust gas recirculated to the intake pipe 30 (not shown).

### Drive Device

As shown in FIG. 2, the vehicle 100 includes a drive device 60. The drive device 60 is located in the engine compartment 110. The drive device 60 includes a motor case 62, a first motor-generator (hereafter, referred to as the first MG) 64, and a second motor-generator (hereafter, referred to as the second MG) 66.

The motor case 62 is located at the left side of the engine 20. The motor case 62 is adjacent to the engine 20, with no other members arranged in between. The motor case 62 has the form of a rectangular parallelepiped in its entirety. An upper end surface 62A of the motor case 62 is the uppermost end of the motor case 62. An upper end surface 62A of the motor case 62 is located at a higher position than the upper end surface 28A of the head cover 28, which is the uppermost end of the engine 20. As shown in FIGS. 1 and 3, for example, a rear end surface of the motor case 62 is located further rearward from the rear end of the engine 20.

As shown in FIG. 2, the motor case 62 accommodates the first MG 64 and the second MG 66. The motor case 62 accommodates a power transmission mechanism (not shown) that transmits power from the first MG 64 and the second MG 66. The first MG 64 is a three-phase AC motor. The first MG 64 has the functionalities of an electric motor and a generator. In the same manner as the first MG 64, the second MG 66 is a three-phase AC motor and has the functionalities of an electric motor and a generator. The first MG 64 and the second MG 66 are drive sources of the vehicle 100. The first MG 64 and the second MG 66 send and receive electric power to and from an on-board battery 74, which will be described below. The first MG 64 and the second MG 66 use the electric power stored in the on-board battery 74 to apply torque to the driving wheels of the vehicle 100. The first MG 64 and the second MG 66 are drive motors used when the vehicle 100 travels.

### Power Related Devices

As shown in FIG. 3, the vehicle 100 includes a connecting device 76, the on-board battery 74, the power supply device 70, and a motor power device 72.

The connecting device 76 is, for example, attached to a body of the vehicle 100. The location of the connecting device 76 is not limited to the position shown in FIG. 3. The connecting device 76 is connectable to an external power source 200. The external power source 200 is an AC power source located outside the vehicle 100.

The on-board battery 74 is, for example, located beneath a floor of the passenger compartment of the vehicle 100. The location of the on-board battery 74 is not limited to the position shown in FIG. 3. The on-board battery 74 is a DC power source in the vehicle 100. The on-board battery 74 a high-voltage battery. The on-board battery 74 has a rated voltage of, for example, approximately 200 to 250 V.

As shown in FIG. 2, the power supply device 70 is located in the engine compartment 110. The power supply device 70 is located on the upper end surface 62A of the motor case 62. As shown in FIG. 3, the power supply device 70 is located within the range of the head cover 28 of the engine 20 in the front-rear direction. The power supply device 70 includes a body and connectors (not shown). The body has the form of a rectangular parallelepiped in its entirety. The body is attached to the upper end surface 62A of the motor case 62 by a bracket or the like. The functionality of the body will be described below. The connectors are located on the upper surface of the body. The connectors are connection ports for cables. The power supply device 70 may be referred to as an on-board charger (OBC).

As shown in FIG. 3, the motor power device 72 is located in the engine compartment 110. In the same manner as the power supply device 70, the motor power device 72 is located on the upper side of the upper end surface 62A of the motor case 62. The motor power device 72 is located at the rear side of the power supply device 70. The motor power device 72 includes a body and connectors. The body has the form of a rectangular parallelepiped in its entirety. The body is attached to the upper end surface 62A of the motor case 62 by a bracket or the like. The functionality of the body will be described below. The connectors are located on the upper surface of the body. The connectors are connection ports for cables. The motor power device 72 may be referred to as a power control unit (PCU). In FIG. 2, the motor power device 72 is not shown.

### Power Path Related to Motor

As shown in FIG. 3, the vehicle 100 includes a first motor cable 91, a second motor cable 92, a third motor cable 93, and a fourth motor cable 94.

The first motor cable 91 and the second motor cable 92 form a first power path extending from the on-board battery 74 to the first MG 64. More specifically, the first motor cable 91 electrically connects the on-board battery 74 and the motor power device 72. The second motor cable 92 electrically connects the motor power device 72 and the first MG 64. The motor power device 72 converts electric power stored in the on-board battery 74 and supplies the converted electric power to the first MG 64. The motor power device 72 also converts the electric power generated by the first MG 64 and supplies the converted electric power to the on-board battery 74. Electric power conversion includes a conversion between direct current and alternating current, and conversion between different direct current voltage levels.

The third motor cable 93 and the fourth motor cable 94 form a second power path extending from the on-board battery 74 to the second MG 66. More specifically, the third motor cable 93 electrically connects the on-board battery 74 and the motor power device 72. The fourth motor cable 94 electrically connects the motor power device 72 and the second MG 66. In the same manner as the first MG 64, the motor power device 72 performs conversion between direct current and alternating current and conversion between different direct current voltage levels with the motor power device 72 and the on-board battery 74.

### External Charging and Power Path Related to EHC

As shown in FIG. 3, the vehicle 100 includes a first charging cable 83, a second charging cable 84, a first EHC cable 81, and a second EHC cable 82.

The first charging cable 83 and the second charging cable 84 form a third power path extending from the connecting device 76 to the on-board battery 74. More specifically, the first charging cable 83 electrically connects the connecting device 76 and the power supply device 70. The second charging cable electrically connects the power supply device 70 and the on-board battery 74. In the third power path, the power supply device 70 converts the alternating current voltage from the external power source 200 to direct current voltage and applies the direct current voltage to the on-board battery 74. The on-board battery 74 receives and is charged with the power supplied from the power supply device 70. Thus, the on-board battery 74 can be charged with electric power from the external power source 200.

The first EHC cable 81 and the second EHC cable 82 form a fourth power path extending from the on-board battery 74 to the EHC 50. More specifically, the first EHC cable 81 electrically connects the on-board battery 74 and the power supply device 70. The second EHC cable 82 electrically connects the power supply device 70 and the EHC 50. In the fourth power path, the power supply device 70 converts output voltage from the on-board battery 74 and supplies the converted voltage to the EHC 50. More specifically, the power supply device 70 converts the voltage level of the direct current voltage from the on-board battery 74 and supplies the converted voltage to the EHC 50. In addition to converting the direct current voltage to different levels, the power supply device 70, may convert the direct current voltage from the on-board battery 74 to alternating current voltage and supply the converted voltage to the EHC 50. This conversion between different direct current voltage levels and the conversion between direct current and alternating current are included in the voltage conversion.

### Layout of Cables

The layout of the second EHC cable 82 will now be described. As described above, as shown in FIG. 2, the upper end surface 62A of the motor case 62 is located at a higher position than the upper end surface 28A of the head cover 28, which is the uppermost end of the engine 20. Therefore, the power supply device 70, which is coupled to the upper end surface 62A of the motor case 62, is located at a higher position than the uppermost end of the engine 20. The exhaust manifold 42 and the EHC 50 that are coupled to the engine 20 extend diagonally downward from the cylinder head 26. Thus, the EHC 50 is located at a lower position than the uppermost end of the engine 20. In such positional relationship between the EHC 50 and the power supply device 70, the second EHC cable 82, which connects the electrodes 56 of the EHC 50 and the power supply device 70, extends upward from the EHC 50. Further, a part of the second EHC cable 82 that is proximate to the power supply device 70 is located at a higher position than the uppermost end of the engine 20. Moreover, the distal end of the second EHC cable 82 is connected to the power supply device 70 at a location higher than the uppermost end of the engine 20. Thus, the second EHC cable 82 includes a specified portion 82A that is located at a higher position than the uppermost end of the engine 20. When a part of the second EHC cable 82 that is not the specified portion 82A is referred to as a remainder portion 82B, the specified portion 82A and the remainder portion 82B are laid out as follows. The EHC 50 is located at the rear side of the engine 20. Thus, the remainder portion 82B is located at the rear side of the engine 20. As shown in FIG. 3, the remainder portion 82B extends leftward from the EHC 50 to a location proximate to the left end of the head cover 28 in the transverse direction. Further, as shown in FIG. 2, the remainder portion 82B extends upward from the EHC 50 to a position higher than the upper end surface 28A of the head cover 28 in the vertical direction. As shown in FIG. 3, the specified portion 82A of the second EHC cable 82 extends frontward immediately above the upper end surface 28A of the head cover 28 and connects to the power supply device 70.

The surrounding structure of the specified portion 82A of the second EHC cable 82 will now be described. As shown in FIG. 2, a region between the upper end surface 62A of the motor case 62 and the hood 120 is referred to as a first region 110A. A region between the upper end surface 28A of the head cover 28 of the engine 20 and the hood 120 is referred to as a second region 110B. In the vehicle 100, the layout in the engine compartment 110 is set so that members are basically not arranged in the first region 110A and the second region 110B. There are substantially no members in the first region 110A except for the power supply device 70, the motor power device 72, and the cables connected to these devices. In the same manner, there are no members in the second region 110B except for the cables. Such a layout results in the hood 120 being located above the specified portion 82A of the second EHC cable 82 without any members located in between.

### Arrangement of Wirings

As shown in FIG. 3, in the same manner as the power supply device 70, the motor power device 72 is coupled to the upper end surface 62A of the motor case 62. Therefore, the cables connected to the power supply device 70 and the motor power device 72 are gathered in the proximity of the upper end surface 62A of the motor case 62. Among the cables, a group of cables located close to one another as a result of where they are connected to are bundled together by a binding member. For example, the second EHC cable 82, the second motor cable 92, and the fourth motor cable 94 are bundled together by a first binding member 98. Further, the second charging cable 84, the first EHC cable 81, the first motor cable 91, and the third motor cable 93 are bundled together by a second binding member 99. The first binding member 98 and the second binding member 99 are, for example, fixed to the motor case 62. The first binding member 98 and the second binding member 99 that bundle the cables into each bundle are schematically shown in FIG. 3. An example of each of the first binding member 98 and the second binding member 99 is a metal fitting.

### Operation of Embodiment

As shown by arrow V in FIG. 1, when the vehicle 100 is traveling forward, air flows over the upper section of the engine compartment 110. As described above, the first region 110A, which is located above the upper end surface 62A of the motor case 62, and the second region 110B, which is located above the upper end surface 28A of the head cover 28 in the engine 20, have substantially no members that block the airflow when the vehicle 100 travels. Thus, when the vehicle 100 travels forward, air flows smoothly in the first region 110A and the second region 110B. Therefore, the flow of air improves the dissipation of heat from the specified portion 82A of the second EHC cable 82, which is located in the first region 110A and the second region 110B. Further, the smooth airflow in the first region 110A and the second region 110B allows air to reach the surroundings of the first region 110A and the second region 110B as a whole. Thus, most of the second EHC cable 82, not just the specified portion 82A, is exposed to the airflow. This further improves the dissipation of heat from the second EHC cable 82. Heat dissipation is not limited to the second EHC cable 82. Heat is also dissipated from the first EHC cable 81, which is connected to the power supply device 70 and the on-board battery 74. Thus, when the air flows smoothly in the first region 110A and the second region 110B, the part of the first EHC cable 81 that is proximate to the power supply device 70 is also exposed to the airflow. As a result, heat dissipation from the first EHC cable 81 is also enhanced.

### Advantages of Embodiment

(1) The power supply device 70, which relays the power supplied between the on-board battery 74 and the EHC 50, is located in the upper section of the engine compartment 110. This allows the second EHC cable 82 to be routed upward from the EHC 50. Consequently, most of the second EHC cable 82 can be arranged in a region where it is readily exposed to the flow of air. In the same manner, the part of the first EHC cable 81 arranged in the upper region of the engine compartment 110 is readily exposed to the airflow. In such an arrangement, a large portion of the cable 81 and the cable 82, which supply electric power to the EHC 50, is cooled by the flow of air. Thus, heat is dissipated effectively from the cable 81 and the cable 82.

(2) The motor case 62, to which the power supply device 70 is coupled, is adjacent to the engine 20. When the power supply device 70 is coupled to the motor case 62, which is adjacent to the engine 20, the distance from the engine 20 and the EHC 50 to the power supply device 70 is shortened. This allows the length of the second EHC cable 82, which connects the EHC 50 and the power supply device 70, to be minimized. In this manner, by coupling the power supply device 70 to the upper end surface 62A of the motor case 62, the second EHC cable 82 can be routed upward and the length of the second EHC cable 82 can be shortened.

(3) As described above, the power supply device 70 is coupled to the upper end surface 62A of the motor case 62. In an assembly plant of the vehicle 100, when connecting the second EHC cable 82 to the power supply device 70, there is an advantage for coupling the power supply device 70 to the upper end surface 62A of the motor case 62. To explain the advantage, the process of connecting the second EHC cable 82 to the power supply device 70 will now be described. Here, the attachment of cables other than the second EHC cable 82 and the coupling of the motor power device 72 to the motor case 62 will not be described.

First, an operator assembles a power transmission unit outside the engine compartment 110 and the vehicle 100. The power transmission unit integrates the drive device 60, the engine 20, the exhaust pipe 40, the EHC 50, the intake pipe 30, and the EGR pipe 35. After the power transmission unit is assembled, the operator couples the second EHC cable 82, which is prepared in advance, to the power transmission unit. More specifically, the operator connects the first end of the second EHC cable 82 to the electrodes 56 of the EHC 50. The operator temporarily fastens the second end of the second EHC cable 82 to the head cover 28 of the engine 20. Then, the operator arranges the power transmission unit, together with the second EHC cable 82, in the engine compartment 110. Afterwards, the operator couples the power supply device 70, which is prepared in advance, to the upper end surface 62A of the motor case 62. Subsequently, the operator detaches the second end of the second EHC cable 82, which was fastened temporarily to the head cover 28 of the engine 20, from the head cover 28. Then, the operator connects the second end of the second EHC cable 82 to the power supply device 70. Through these series of processes, the operator couples the second EHC cable 82 to the power supply device 70.

A comparative example in which the power supply device 70 is arranged separately from the power transmission unit and coupled to the lower section of the engine compartment 110 will now be described. In the comparative example, depending on the location of the power supply device 70, in a state in which the power transmission unit is accommodated in the engine compartment 110, the operator may not be able to visually locate the connectors of the power supply device 70. Further, when the power supply device 70 is located in the lower section of the engine compartment 110, in order to connect the second end of the second EHC cable 82 to the power supply device 70, the operator needs to reach the bottom of the engine compartment 110 with a hand. In this case, the various components in the engine compartment 110 may interfere with the tasks performed by the operator. This lowers efficiency when connecting the second EHC cable 82 to the power supply device 70 in the comparative example.

In this regard, if the power supply device 70 is coupled to the upper end surface 62A of the motor case 62, when connecting the second EHC cable 82, the power supply device 70 is exposed and can be viewed by the operator. Therefore, the operator can visually locate the connector of the power supply device 70 and connect the second EHC cable 82 to the power supply device 70. Additionally, since the power supply device 70 is located in the uppermost section of the engine compartment 110, when the operator connects the second EHC cable 82 to the power supply device 70, the various components in the engine compartment 110 will not interfere with the operator. This improves the efficiency for connecting the second EHC cable 82 to the power supply device 70.

(4) The power supply device 70 and the motor power device 72 are both coupled to the upper end surface 62A of the motor case 62. In this case, the cables attached to the power supply device 70 and the cables attached to the motor power device 72 are located close to one another. Therefore, the cables of different systems connected to the power supply device 70 and the motor power device 72 can be bound together into a single bundle. The cables of different systems that are bound together, allow the engine compartment 110 to maintain an orderly structure.

(5) No components are arranged between the specified portion 82A of the second EHC cable 82 and the hood 120. This allows air to readily flow, especially, between the specified portion 82A and the hood 120. Thus, heat dissipation of the specified portion 82A and the surroundings of the specified portion 82A is further improved.

(6) The power supply device 70 has a functionality for performing voltage conversion when charging the on-board battery 74 and a functionality for performing voltage conversion when supplying power to the EHC 50. Thus, the vehicle 100 has less components than when the vehicle 100 includes separate devices for the two functionalities.

(7) Exhaust gas flows through the EGR pipe 35. This increases the temperature of the EGR pipe 35. Here, the EHC 50 and the intake pipe 30, which are where the EGR pipe 35 is connected to, are located at the opposite sides of the engine 20. Therefore, if the EGR pipe 35 is coupled to the EHC 50 and to the intake pipe 30 outside the engine 20, the EGR pipe 35 will have to extend around the engine 20. This lengthens the EGR pipe 35. The long EGR pipe 35 will increase the area in which the EGR pipe 35 is laid out, and thereby increase the probability of the second EHC cable 82 being positioned near the EGR pipe 35 will increase. In this case, the second EHC cable 82, positioned near the EGR pipe 35, may be affected by the heat of the EGR pipe 35.

In this regard, the EGR pipe 35 extends through the engine 20. Therefore, the EGR pipe 35 extends from the EHC 50 to the intake pipe 30 through the shortest route possible. This shortens the part of the EGR pipe 35 located outside the engine 20. As a result, the second EHC cable 82 can be arranged distanced from the EGR pipe 35.

### Modifications

The above-described embodiment may be modified as follows. The above-described embodiment and the following modifications can be combined as long as the combined modifications remain technically consistent with each other.

The EGR pipe 35 is not limited to the exemplified structure of the above embodiment. The EGR pipe 35 may have any structure as long as it is connected to the intake pipe 30 to an exhaust gas passage defined by the exhaust pipe 40 and the EHC 50. For example, the intermediate portion 35B of the EGR pipe 35 may extend through the right end of the cylinder head 26 in the front-rear direction. In this case, the layout of the upstream portion 35A and the downstream portion 35C should be changed from the examples of the above embodiment in accordance with the layout of the intermediate portion 35B. As described in the above embodiment, the entire EGR 35 pipe does not need to be a tube-shaped pipe as long as the entire EGR pipe 35 forms a single continuous passage.

The exhaust gas passage and the connecting points of the EGR pipe 35 are not limited to the examples of the above embodiment. For example, the upstream portion 35A of the EGR pipe 35 may be connected to the downstream pipe 44. The connecting points of the intake pipe 30 of the EGR pipe 35 are also not limited to the examples of the above embodiment.

The EGR pipe 35 does not need to extend through the inside of the engine 20. In other words, the entire EGR pipe 35 may be located outside of the engine 20. When the entire EGR pipe 35 is located outside of the engine 20, the EGR pipe 35 is distanced from the cables.

The EGR pipe 35 may be omitted. Exhaust gas recirculation may be unnecessary depending on the structure of the engine 20.

The vehicle 100 may include a charging voltage converter, which converts voltage, between the external power source 200 and the on-board battery 74, in addition to the power supply device 70, which converts voltage, between the on-board battery 74 and the EHC 50. In this case, instead of arranging the charging voltage converter in the engine compartment 110, the voltage converter may be arranged beneath the floor of the passenger compartment of the vehicle 100 so that the number of components in the engine compartment 110 does not increase.

The charging functionality that uses the external power source 200 may be omitted from the vehicle 100. In this case, each device related to the charging function may be omitted. In other words, the vehicle 100 is not limited to a plug-in hybrid electric vehicle.

A member may be arranged between the specified portion 82A of the second EHC cable 82 and the hood 120. There are few objects in the upper section of the engine compartment 110 that block the flow of air. Therefore, air readily flows over the upper section of the engine compartment 110. Thus, even if a member is arranged between the specified portion 82A of the second EHC cable 82 and the hood 120, head dissipation of the specified portion 82A will still be improved.

The first region 110A and the second region 110B are not limited to the exemplified member layout of the above embodiment. In the first region 110A and the second region 110B, members other than the power supply device 70, the motor power device 72, and the cables connected to these cables may be arranged. In this case, as described in the above modification, air readily flows through the upper section of the engine compartment 110. Thus, when at least a part of the EHC cable 82 is located above the upper end surface 28A of the head cover 28, heat dissipation of the second cable 82 may be improved.

Each cable is not limited to the exemplified routing of the above embodiment. Each cable may be routed so that the required electric power is supplied to the connected device. As long as at least a part of the second EHC cable 82 is located above the upper end surface 28A of the head cover 28, the second EHC cable 82 may be routed in any manner. Here, the phrase of located above the upper end surface 28A of the head cover 28 is not limited to a state located above the entire upper end surface 28A of the head cover 28. In other words, as long as at least a part of the second EHC cable 82 is located above the lowest portion of the upper end surface 28 of the head cover 28, the second EHC cable 82 may be routed in any manner.

The motor power device 72 is not limited to the exemplified location of the above embodiment. For example, the motor power device 72 does not have to be located above the upper end surface 62A of the motor case 62 in the engine compartment 110. Further, the motor power device 72 may be located outside the engine compartment 110, such as at the rear side of the engine compartment 110 in the vehicle 100. As long as the motor power device 72 is arranged proximate to the motor case 62, the cable that connects the motor power device 72 and the drive motor can be shortened.

The power supply device 70 is not limited to the exemplified location of the above embodiment. For example, the power supply device 70 does not have to be located on the upper end surface 62A of the motor case 62 in the engine compartment 110. Further, the power supply device 70 may be located outside the engine compartment 110, such as the rear side of the engine compartment 110 in the vehicle 100. Even if the location of the power supply device 70 is changed from the example of the above embodiment, by adjusting the routing of the cable that connects the power supply device 70 and the EHC 50, at least a part of the cable connecting the power supply device 70 and the EHC 50, which is located in the engine compartment 110, can be located above the upper end surface 28A of the head cover 28.

The motor case 62 is not limited to the exemplified structure of the above embodiment. The motor case 62 may have any structure as long as it accommodates one or more drive motors. For example, the shape of the motor case may be changed from the example of the above embodiment. Even if the motor case 62 is changed from the example of the above embodiment, the uppermost end of the motor case 62 is set in correspondence with the vertical direction of the vehicle 100.

The motor case 62 is not limited to the exemplified arrangement of the above embodiment. For example, the motor case 62 may be arranged in a state in which other members are located between the motor case 62 and the engine 20.

The number of the drive motors in the above embodiment is not a limitation. The vehicle 100 may include any number of drive motors necessary to apply the desired amount of torque to the driving wheels.

The drive motors and the motor case 62 may be omitted from the vehicle 100. In this case, the motor power device 72 and the cables connected to the motor power device 72 may be omitted.

For example, when the drive motors are omitted from the vehicle 100, the on-board battery 74 may be an auxiliary low-voltage battery. The rated voltage for the low-voltage battery is, for example, 12 to 48 V.

In regard to the voltage conversion functionality of the power supply device 70, the power supply device 70 does not need to convert the direct current voltage level from the on-board battery 74 and may simply convert direct current voltage to alternating current that is supplied to the EHC 50. Voltage conversion suitable for the level of voltage output of the on-board battery 74 is performed.

The power supply device 70 does not need to have a voltage conversion functionality as long as the power supply device 70 supplies electric power to the EHC 50. The power supply device 70 may be, for example, a battery.

The engine 20 is not limited to the exemplified location of the above embodiment as long as the engine 20 is arranged in the engine compartment 110. For example, the engine 20 may be arranged so that cylinders 24A are arranged in the front-rear direction of the vehicle 100. Moreover, the engine 20 may be inclined forward with respect to the vertical direction of the vehicle 100 or be arranged in the vertical direction of the vehicle 100.

The engine 20 is not limited to the exemplified structure of the above embodiment. For example, the engine 20 may be a V-engine in which two banks of cylinders are V-shaped. The structures of the intake pipe 30 and the exhaust pipe 40 may be changed in accordance with the structure of the engine 20.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An engine compartment structure for a vehicle, the engine compartment structure comprising:
an engine located in an engine compartment of a vehicle;
an exhaust pipe extending from the engine, wherein exhaust gas from the engine flows through the exhaust pipe;
an electrically heated catalyst that generates heat when energized including a catalyst carrier carrying a catalyst, wherein the electrically heated catalyst and the exhaust pipe define a flow passage for the exhaust gas in the engine compartment; and
a cable connecting the electrically heated catalyst and a power supply device that supplies electric power to the electrically heated catalyst, wherein
at least a part of the cable is located at an upper side of an upper end surface of a head cover that covers a cylinder head of the engine.

2. The engine compartment structure according to claim 1, further comprising:
a motor case located adjacent to the engine and accommodating at least one drive motor,
wherein the power supply device is located on an upper side of an uppermost end of the motor case and is coupled to the motor case.

3. The engine compartment structure according to claim 2, further comprising:
a motor power device supplying electric power to the drive motor; and
a motor cable connecting the motor power device and the drive motor,
wherein the motor power device is located on an upper side of the uppermost end of the motor case and is coupled to the motor case.

4. The engine compartment structure according to claim 1, wherein
the cable includes a specified portion located at a higher position than an uppermost end of the engine, and
a hood is located above the specified portion without any other member arranged in between.

5. The engine compartment structure according to claim 1, wherein
the vehicle is a plug-in hybrid electric vehicle including an on-board battery that is chargeable by an external power source, and
the power supply device is configured to convert an alternating current voltage from the external power source to a direct current voltage and apply the direct current voltage to the on-board battery and is configured to convert output voltage from the on-board battery and supply the converted voltage to the electrically heated catalyst.

6. The engine compartment structure according to claim 1, further comprising:
an EGR pipe configured to recirculate the exhaust gas to an intake pipe that draws in intake air from the engine; and
the EGR pipe extends from the flow passage for the exhaust gas and through the engine, and the EGR pipe is connected to the intake pipe at a side of the engine opposite the flow passage for the exhaust gas.
